(19) United States
(12) Patent Application Publication
(10) Pub. No.: US 2014/0278470 A1
(43) Pub. Date: Sep. 18, 2014

(54) APPARATUS, SYSTEM, AND METHOD FOR DETERMINING A WELLNESS RATING FOR AN ORGANIZATION

(71) Applicant: THE PRESIDIO GROUP, INC., Salt Lake City, UT (US)

(72) Inventor: John D. Schlichte, Mountain Green, UT (US)

(73) Assignee: THE PRESIDIO GROUP, INC., Salt Lake City, UT (US)

(21) Appl. No.: 13/839,370

(22) Filed: Mar. 15, 2013

(51) Int. Cl. G06F 19/00

(52) U.S. Cl. CPC G06F 19/3431
USPC 705/2

(57) ABSTRACT

A computer program product for determining a wellness rating for an organization. The computer program product records measurements of a plurality of wellness factors for a plurality of individuals related to an organization, determines a raw score of each wellness factor for the organization, generates a relative score of each wellness factor for the organization based upon the raw score and a baseline score for each wellness factor, and calculates a wellness rating for the organization based upon the relative scores of each wellness factor.

### FIELD

This invention relates to determining a wellness rating for an organization and more particularly relates to a method for determining a wellness rating for an organization based on comparing measurements of a plurality of wellness factors for an organization to a baseline.

### BACKGROUND

For organizations that provide healthcare insurance to its employees and their families, healthcare insurance premiums have, over time, increased as a percentage of their overall expenditures. An employer's health insurance premiums are primarily based on the health of its employees and their covered family members and/or dependents, specifically the cost of their health insurance claims. Despite this, employers often have limited information regarding the health of their employees and covered family members and/or dependents, whether as individuals or in the aggregate. Federal and state laws restrict access to an individual's medical data, and insurers often do not release aggregate data or statistics to employers regarding employees' medical claims. Thus, when an employer's health insurance premiums go up, it often does not know the bases for the increased cost.

For employers, the effect of poor health among employees and their covered dependents goes beyond higher health insurance premiums. Productivity suffers when an employee misses work due to personal or family illness. In certain industries, poor health may lead to an increased rate of workplace injuries, and therefore, increased worker's compensation claims. In extreme cases, employers may have to replace employees altogether, resulting in lost productivity and higher training costs.

To address the negative effects stated above, some employers have tried to encourage employees and their families to live healthier lifestyles through financial and other types of incentives. A common example is a company rewarding employees for quitting smoking with gift cards, cash, or a reduction in employees' health insurance premiums. The hope is that such efforts will lead to increased productivity and lower health insurance costs. But without detailed data or evidence showing consistent improvements in employee health relative to a baseline, employers lack leverage in any negotiation with insurers to reduce health insurance premiums.

### BRIEF SUMMARY

A computer program product for determining a wellness rating of an organization records measurements of a plurality of wellness factors for a plurality of individuals related to an organization, determines a raw score of each wellness factor for the organization, generates a relative score of each wellness factor for the organization based upon the raw score and a baseline score for each wellness factor, and calculates a wellness rating for the organization based upon the relative scores of each wellness factor. In one embodiment, to determine a raw score of a wellness factor for an organization includes calculating the percentage of individuals of the plurality of individuals whose measurement for the wellness factor fall outside a standard range for the wellness factor. In another embodiment, to generate a relative score for a wellness factor includes calculating the ratio between the raw score and the baseline score for the wellness factor. In a further embodiment, to calculate the wellness rating for an organization includes averaging the relative scores of each wellness factor. In yet another embodiment, the baseline score of a wellness factor includes the average raw score of the wellness factor for a plurality of other organizations. In an embodiment, each organization is substantially in the same industry. In another embodiment, each organization is substantially located within the same geographic region. In a particular embodiment, each organization substantially shares one or more demographics. In a certain embodiment, the one or more demographic characteristics is selected from the group consisting of age, gender, race, ethnicity, and income.

An apparatus for determining a wellness rating for an organization includes an input module, a scoring module, a rating module, and a report module. In one embodiment, the input module receives and records measurements of a plurality of wellness factors for a plurality of individuals related to an organization. In another embodiment, the scoring module determines a raw score of each wellness factor for the organization and, using the raw score and a baseline score for each wellness factor, generates a relative score of each wellness factor for the organization. In a further embodiment, the rating module calculates a wellness rating for the organization based upon the relative scores of each wellness factor. In a certain embodiment, the reporting module displays one or more of (i) measurements of each wellness factor for an individual; (ii) the baseline scores for each wellness factor, (iii) the raw scores for each wellness factor, and (iv) the wellness rating for the organization.

In one embodiment, the raw score of each wellness factor includes calculating the percentage of individuals of the plurality of individuals whose measurement for the wellness factor fall outside a standard range for the wellness factor. In another embodiment, the relative score of each wellness factor includes calculating the ratio between the raw score and a baseline score for the wellness factor. In yet another embodiment, the wellness rating for an organization includes averaging the relative scores of each wellness factor. In a further embodiment, the baseline score of a wellness factor includes the average raw score of the wellness factor for a plurality of other organizations. In an embodiment, each organization is substantially in the same industry. In another embodiment, each organization is substantially located in the same geographic region. In a further embodiment, each organization shares one or more demographic characteristics. In yet another embodiment, the one or more shared demographic characteristics is selected from the group consisting of age, gender, race, ethnicity, and income.

A system for determining a wellness rating includes a server and a wellness rating apparatus. The wellness rating apparatus includes an input module, a scoring module, a rating module, and a report module. In one embodiment, the input module receives and records measurements of a plurality of wellness factors for a plurality of individuals related to an organization. In another embodiment, the scoring module determines a raw score of each wellness factor for the organization and, using the raw score and a baseline score for each wellness factor, generates a relative score of each wellness factor for the organization. In a further embodiment, the rating module calculates a wellness rating for the organization based upon the relative scores of each wellness factor. In a certain embodiment, the reporting module displays one or more of (i) measurements of each wellness factor for an individual; (ii) the baseline scores for each wellness factor, (iii) the raw scores for each wellness factor, and (iv) the wellness rating for the organization.

A method for determining a wellness rating including measuring a plurality of wellness factors for a plurality of individuals related to an organization, determining a raw score of each wellness factor for the organization, generating a relative score of each wellness factor for the organization based upon the raw score and a baseline score for the wellness factor, and calculating a wellness rating for the organization based upon the relative scores of each wellness factor.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for determining a wellness rating;

FIG. 2 is a schematic block diagram illustrating one embodiment of an apparatus for determine a wellness rating;

FIG. 3 is an example screenshot illustrating one embodiment of a computer program product for determining a wellness rating;

FIG. 4 is an example screenshot illustrating another embodiment of a computer program product for determining a wellness rating;

FIG. 5 is an example screenshot illustrating yet another embodiment of a computer program product for determining a wellness rating;

FIG. 6 is an example screenshot illustrating a further embodiment of a computer program product for determining a wellness rating; and

FIG. 7 is a schematic flow chart diagram illustrating an embodiment of a method for determining a wellness rating.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

The computer program product may be integrated into a client, server and network environment by providing for the computer program product to coexist with applications, operating systems and network operating systems software and then installing the computer program product on the clients and servers in the environment where the computer program product will function.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of preceding figures. Like numbers refer to like elements in all figures, including alternate embodiments of like elements.

FIG. 1 is a schematic block diagram illustrating one embodiment of a system for determining a wellness rating. The system 100 includes a wellness rating apparatus 102 on a server 104, a client 106 with a software application 108, and a computer network 110, which are described below.

In one embodiment, the system 100 includes a wellness rating apparatus 102 on a server 104. The wellness rating apparatus 102 calculates a wellness rating for an organization based upon measurements of a plurality of wellness factors for persons relating to the organization. The wellness rating apparatus 102 is described in more detail with respect to the apparatus 200 of FIG. 2. The server 104 may be a mainframe computer, a blade server, a workstation, a desktop computer, or other computer. The server 104, in one embodiment, includes a plurality of processors, such as a partitioned mainframe with multiple operating system instances. In another embodiment, the server 104 includes one or more subsystems, such as a storage area network. The server 104, may access internal or external storage accessible through a network. The client 106 may be a desktop computer, a laptop, a tablet computer, a smartphone, or other electronic device. The software application 108 on the client 106 may be a web browser, a database application, or other computer program. The client 106 and server 104 are connected by a computer network 110. The computer network 110 may include a local area network (“LAN”), a wide area network (“WAN”), wireless network, cellular network, the internet, or the like. In this embodiment, information is sent from a software application 108 on a client 106 to the wellness rating apparatus 102 on the server 104.

In another embodiment, the wellness rating apparatus 102 resides on both the server 104 and the client 106. In this instance, the wellness rating apparatus 102 has portions residing on the server 104 and the client 106. The client-side portion of the wellness rating apparatus 102 may reside within a software application 108 on a client 106, or it may run on a client 106 apart from a software application 108. In one embodiment, measurements of a plurality of wellness factors for an individual is sent from a software application 108 on a client 106 to the client side portion of the wellness rating apparatus 102. In an alternative embodiment, the client-side portion of the wellness rating apparatus 102 residing within a software application 108 receives measurements of a plurality of wellness factors for a plurality of individuals. A wellness factor can include height, weight, tobacco use, cholesterol (e.g., HDL, LDL, VLDL) levels, triglyceride levels, blood pressure, waist circumference, body mass index (BMI), or other biomedical characteristics. One of skill in the art will recognize other wellness factors.

In a further embodiment, the wellness rating apparatus 102 resides on the client. In this instance, the wellness rating apparatus 102 runs on the client 106 as a standalone application. In one embodiment, the wellness rating apparatus 102 receives measurements of a plurality of wellness factors for an individual and stores it on the client 106. In one example, the measurements of a plurality of wellness factors may be stored in a database. In another example, the measurements may be stored in a file. The database or file may be encrypted and/or password protected to protect medical privacy.

FIG. 2 is a schematic block diagram illustrating one embodiment of an apparatus for determine a wellness rating. The apparatus 200 includes one embodiment of a wellness rating apparatus 102 with an input module 202, a scoring module 204, a rating module 206, and a reporting module 208, which are described below.

In one embodiment, the input module 202 receives and records measurements of a plurality of wellness factors for a plurality of individuals related to an organization. The input module 202 may receive measurements in a variety of ways. For example, the input module 202 may receive measurements through manual input such as a keyboard. In another example, the input module 202 may receive measurements as a data stream from a software application 108. In a further example, the input module 202 may receive measurements by reading a file from the storage media on a client 106. An individual may be related to an organization in different ways. In one embodiment, an individual is related to an organization if he/she is employed by the organization. In another embodiment, an individual is related to an organization if he/she is a member of the organization. In a further embodiment, an individual is related to an organization if he/she is covered by a health insurance plan paid for by the organization.

The scoring module 204 determines a raw score and a relative score of each wellness factor for the organization. In one embodiment, a raw score for a wellness factor for an organization is the percentage of individuals of the plurality of individuals related to the organization whose measurement for that wellness factor fall outside a standard range for the wellness factor. Alternatively, a raw score may be the percentage of individuals of the plurality of individuals related to the organization whose measurements for that wellness factor fall within a standard range for the wellness factor. The standard range for a wellness factor may include a range of values considered to be healthy for an individual by government authorities (e.g., National Institutes of Health), peer reviewed medical studies, or respected medical associations (e.g., American Medical Association, state medical associations). In one embodiment, a relative score of a wellness factor for the organization is the ratio between the raw score and a baseline score for the wellness factor.

A baseline score for a wellness factor may be determined in different ways. In one embodiment, a baseline score for a wellness factor is the national average percentage for the wellness factor as published by government authorities (e.g., Center for Disease Control, National Center for Health Statistics). In another embodiment, a baseline score for a wellness factor may be the average raw scores of the wellness factor for a plurality of other organizations. These other organizations and the first organization may share one or more common characteristics. In one embodiment, each organization may be substantially in the same industry (e.g., airlines). In another embodiment, each organization is substantially located in the same geographic region (e.g., businesses located within 10 miles of downtown Minneapolis). In a further embodiment, each organization substantially shares one or more demographic characteristics, including but not limited to, age, gender, race, ethnicity, and income (e.g., AARP and other retiree groups).

The rating module 206 calculates a wellness rating for an organization based upon the relative scores of each wellness factor. In one embodiment, the wellness rating is the average of the relative scores of each wellness factor. In another embodiment, the wellness rating is the weighted average of the relative scores of each wellness factor. One of skill in the art will recognize other formulas for calculating a numerical rating given a plurality of numbers.

The reporting module 208 displays measurements of wellness factors for individuals, the raw score of each wellness factor, a baseline score of each wellness factor, and the wellness rating for an organization. The reporting module 208 may display each of these numerical figures in different ways. These numerical figures may be displayed as numbers, in a chart, or in a graph. One of skill in the art will recognize other ways that these figures can be displayed.

FIG. 3 is an example screenshot illustrating one embodiment of a computer program product for determining a wellness rating. In FIG. 3, the screenshot shows a form 300 that can be used to record and display measurements of a plurality of wellness factors for an individual employed by a company. In one embodiment, the form 300 has a personal profile section 302 for recording and displaying an individual's personal and employment information, including but not limited to, the individual's name, company name, employee id, contact information, date of birth, and date of hire. In an alternate embodiment, the form 300 may contain, in the personal profile section 302, entries for organization name, membership id, and the date that the individual became a member of the organization. In another embodiment, the personal profile section 302 may also record and display the relationship between two individuals (e.g., spouse, child, other dependent to an employee or member). The form 300 also has a wellness profile section 304 for recording and displaying an individual's wellness measurements over time. In one embodiment, the wellness profile section 304 records and displays measurements of wellness factors and the date that a measurement was taken. In another embodiment, the wellness profile section 304 may also record and display related information, such as whether an individual has received his/her measurements or advise/coaching to improve his/her wellness. For example, an individual may receive counseling from a health professional on how to improve his/her wellness. Such counseling may focus on topics including but not limited to, quitting tobacco use, healthy eating, exercise, and stress management. One of skill in the art will recognize other wellness-related information that may be recorded and displayed in the wellness profile section 304.

FIG. 4 is an example screenshot illustrating another embodiment of a computer program product for determining a wellness rating. In FIG. 4, the screenshot shows a report 400 of the measurements of a plurality of wellness factors for a plurality of individuals related to an organization. In this embodiment, the report 400 summarizes the percentage of employees in a company who had zero to five risk factors (e.g., measured outside a standard range for a wellness factor) in their wellness profile compared to a baseline standard. The report 400 may present other summaries of measurements of wellness factors. In one embodiment, the report 400 may depict the percentage of employees in a company who had zero to five risk factors over time. In another embodiment, the report 400 may summarize the measurements of each wellness factor for an individual over time. The information shown in report 400 may also be depicted in other forms, including but not limited to, table form. One of skill in the art will recognize other ways that information may be depicted or summarized in report 400.

FIG. 5 is an example screenshot illustrating yet another embodiment of a computer program product for determining a wellness rating. In FIG. 5, the screenshot shows a report 500 of the raw scores of a plurality of wellness factors for an organization. In this embodiment, the report 500 depicts, for each wellness factor, the percentage of employees in a company who measured outside a standard range for that wellness factor. The report 500 also shows a baseline score for each wellness factor. The information shown in report 500 may also be depicted in other forms, including but not limited to, table form. One of skill in the art will recognize other ways this information may be depicted or summarized in report 500.

FIG. 6 is an example screenshot illustrating a further embodiment of a computer program product for determining a wellness rating. In FIG. 6, the screenshot shows a report 600 of the wellness rating for an organization. In this embodiment, the report 600 depicts, over time, the wellness rating for an organization. In this example, the standard wellness rating is 1.00. The report 600 allows an organization to track its wellness rating over time. This information may be used by the organization to negotiate with health insurers for lower insurance premiums. An improvement in an organization's health rating indicates that the organization's members are improving in health and therefore less likely to become ill and file health insurance claims. As a result, an insurer will likely pay out less in claims. The information shown in report 600 may also be depicted in other forms, including but not limited to, table form. One of skill in the art will recognize other ways this information may be depicted or summarized in report 600.

FIG. 7 is a schematic flow chart diagram illustrating an embodiment of a method 700 for determining a wellness rating. The method 700 begins and in one embodiment, measures 702 a plurality of wellness factors for a plurality of individuals related to an organization. The method 700 determines 704 a raw score of each wellness factor for the organization. In one embodiment, the scoring module 204 determines 704 a raw score of each wellness factor by calculating the percentage of individuals of the plurality of individuals whose measurement for the wellness factor fall outside a standard range for the wellness factor. The method 700 generates 706 a relative score of each wellness factor for the organization using the raw score and a baseline score for the wellness factor. In one embodiment, the scoring module 204 generates a relative score of each wellness factor by calculating the ratio between the raw score and a baseline score for the wellness factor. The method 700 calculates 708 the wellness rating for the organization based upon the relative scores for each wellness factor and the method 700 ends. In one embodiment, the rating module 206 calculates a wellness rating by averaging the relative scores of each wellness factor pertaining to the organization.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product for determining a wellness rating, the computer program product comprising a computer readable storage medium having program code embodied therein, the program code readable/executable by a process to:
record measurements of a plurality of wellness factors for a plurality of individuals related to an organization;
determine a raw score of each wellness factor for the organization;
generate a relative score of each wellness factor for the organization based upon the raw score and a baseline score for each wellness factor; and
calculate a wellness rating for the organization based upon the relative scores of each wellness factor.

2. The computer program product of claim 1, wherein to determine a raw score of a wellness factor for an organization further comprises calculating the percentage of individuals of the plurality of individuals whose measurement for the wellness factor fall outside a standard range for the wellness factor.

3. The computer program product of claim 1, wherein to generate a relative score for a wellness factor further comprises calculating the ratio between the raw score and the baseline score for the wellness factor.

4. The computer program product of claim 1, wherein to calculate the wellness rating for an organization further comprises averaging the relative scores of each wellness factor.

5. The computer program product of claim 1, wherein the baseline score of a wellness factor comprises the average raw score of the wellness factor for a plurality of other organizations.

6. The computer program product of claim 5, wherein each organization is substantially in the same industry.

7. The computer program product of claim 5, wherein each organization is substantially located within the same geographic region.

8. The computer program product of claim 5, wherein each organization substantially shares one or more demographic characteristics.

9. The computer program product of claim 8, wherein the one or more demographic characteristics is selected from the group consisting of age, gender, race, ethnicity, and income.

10. An apparatus comprising:
an input module that receives and records measurements of a plurality of wellness factors for a plurality of individuals related to an organization;
a scoring module that determines a raw score of each wellness factor for the organization and, using the raw score and a baseline score for each wellness factor, generates a relative score of each wellness factor for the organization;
a rating module that calculates a wellness rating for the organization based upon the relative scores of each wellness factor;
a reporting module that displays one or more of (i) measurements of each wellness factor for an individual; (ii) the baseline scores for each wellness factor, (iii) the raw scores for each wellness factor, and (iv) the wellness rating for the organization;
wherein at least a portion of the input module, the scoring module, the rating module, and the reporting module comprise one or more of hardware and executable code, the executable code stored on one or more computer readable storage media.

11. The apparatus of claim 10, wherein the raw score of each wellness factor comprises calculating the percentage of individuals of the plurality of individuals whose measurement for the wellness factor fall outside a standard range for the wellness factor.

12. The apparatus of claim 10, wherein the relative score of each wellness factor comprises calculating the ratio between the raw score and the baseline score for the wellness factor.

13. The apparatus of claim 10, wherein the wellness rating for an organization comprises averaging the relative scores of each wellness factor.

14. The apparatus of claim 10, wherein the baseline score of a wellness factor comprises the average raw score of the wellness factor for a plurality of other organizations.

15. The apparatus of claim 14, wherein each organization is substantially in the same industry.

16. The apparatus of claim 14, wherein each organization is substantially located within the same geographic region.

17. The apparatus of claim 14, wherein each organization substantially shares one or more demographic characteristics.

18. The apparatus of claim 17, wherein the one or more demographic characteristics is selected from the group consisting of age, gender, race, ethnicity, and income.

19. A system comprising:
a server; and
a wellness rating apparatus executing at least partially on the server, the wellness rating apparatus comprising:
an input module that receives and records measurements of a plurality of wellness factors for a plurality of individuals related to an organization;
a scoring module that determines a raw score of each wellness factor for the organization and, using the raw score and a baseline score for each wellness factor, generates a relative score of each wellness factor for the organization;
a rating module that calculates a wellness rating for the organization based upon the relative scores of each wellness factor;
a reporting module that displays one or more of (i) measurements of each wellness factor for an individual; (ii) the baseline scores for each wellness factor, (iii) the raw scores for each wellness factor, and (iv) the wellness rating for the organization.

20. A method for determining a wellness rating, comprising:
measuring a plurality of wellness factors for a plurality of individuals related to an organization;
determining a raw score of each wellness factor for the organization;
generating a relative score of each wellness factor for the organization based upon the raw score and a baseline score for the wellness factor; and
calculating a wellness rating for the organization based upon the relative scores of each wellness factor.
